(19) United States
(12) Patent Application Publication
(10) Pub. No.: US 2023/0238572 A1
(43) Pub. Date: Jul. 27, 2023

(54) NEW SOLID SULFIDE ELECTROLYTES

(71) Applicants: Solvay SA, Brussels (BE); Centre National de la Recherche Scientifique, Paris (FR); UNIVERSITE DE PICARDIE JULES VERNE, Amiens (FR)

(72) Inventors: Marc-David Braida, Bry sur Marne (FR); Thierry Le Mercier, Rosny-sous-Bois (FR); Christian Masquelier, Boves (FR); Omer Kudu, Amiens (FR)

(73) Assignees: Solvay SA, Brussels (BE); Centre National de la Recherche Scientifique, Paris (FR); UNIVERSITE DE PICARDIE JULES VERNE, Amiens (FR)

(21) Appl. No.: 17/999,796

(22) PCT Filed: May 25, 2021
(86) PCT No.: PCT/EP2021/063911

§ 371 Date: Nov. 23, 2022

(30) Foreign Application Priority Data
May 26, 2020 (EP) 20176525.2

(51) Int. Cl. H01M 10/0562

(52) U.S. Cl. CPC H01M 10/0562; H01M 2300/0068

(57) ABSTRACT

The present invention concerns a new solid material according to general formula (I) as follows: Li₄₋₂ₓZnₓP₂S₆ (I) wherein 0<x≤1. The invention also refers to a method for producing a solid material comprising at least bringing at least lithium sulfide, phosphorous sulfide, and a zinc compound, optionally in one or more solvents. The invention also refers to said solid materials and their use as solid electrolytes notably for electrochemical devices.

This application claims priority filed on 26 May 2020 in EUROPE with Nr 20176525.2, the whole content of this application being incorporated herein by reference for all purposes.

The present invention concerns a new solid material according to general formula (I) as follows: Li₄₋₂ₓZnₓP₂S₆ (I) wherein 0<x≤1. The invention also refers to a method for producing a solid material comprising at least bringing at least lithium sulfide, phosphorous sulfide, and a zinc compound, optionally in one or more solvents. The invention also refers to said solid materials and their use as solid electrolytes notably for electrochemical devices.

### PRIOR ART

Lithium batteries are used to power portable electronics and electric vehicles owing to their high energy and power density. Conventional lithium batteries make use of a liquid electrolyte that is composed of a lithium salt dissolved in an organic solvent. The aforementioned system raises security questions as the organic solvents are flammable. Lithium dendrites forming and passing through the liquid electrolyte medium can cause short circuit and produce heat, which result in accident that leads to serious injuries. Since the electrolyte solution is a flammable liquid, there is a concern of occurrence of leakage, ignition or the like when used in a battery. Taking such concern into consideration, development of a solid electrolyte having a higher degree of safety is expected as an electrolyte for a next-generation lithium battery.

Non-flammable inorganic solid electrolytes offer a solution to the security problem. Furthermore, their mechanic stability helps suppressing lithium dendrite formation, preventing self-discharge and heating problems, and prolonging the life-time of a battery.

Solid sulfide electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries. Due to the wide-spread use of all solid state lithium batteries, there is an increasing demand for solid state electrolytes having a high conductivity for lithium ions.

As an example of a relatively stable solid electrolyte, Li₄P₂S₆, lithium hexathiohypodiphosphate, has been identified in several high temperature preparations of lithium thiophosphate electrolytes as a synthesis or decomposition product. Its characteristic P—P bond may be partly responsible for its relative high thermal, moisture and electrochemical stabilities. However, ionic conductivity of Li₄P₂S₆ is modest, impairing its use as solid electrolyte.

There is however a need for new solid sulfide electrolytes having optimized performances from the viewpoint of achieving higher output of a battery, such as higher ionic conductivity and lower activation energy, without compromising other important properties like chemical and mechanical stability.

### INVENTION

Surprisingly it has been found that new solid sulfide electrolytes having higher ionic conductivity and lower activation energy in comparison with usual Li₄P₂S₆ materials may be obtained by using zinc dopant. The new LiZnPS solid materials of the invention also exhibits at least similar chemical and mechanical stability and processability like those conventional lithium sulfide electrolytes. Solid materials of the invention may also be prepared with improved productivity and allowing a control of the morphology of the obtained product. Furthermore, solid materials of the invention exhibit a lower amount of raw materials impurity, such as Li₂S. Solid materials of the invention exhibit also a lower amount of undesired phases, such as Gamma-Li₃PS₄. Also, phases of the invention offer an improvement in the ionic conductivity at room temperature of three order of magnitude compared to Li₄P₂S₆ and better than the previous dopant reported with Sc and Mg. Additionally these phases exhibit an enhanced moisture stability with a lower release of H₂S compared to undoped Li₄P₂S₆.

The present invention refers then to a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C. Preferably said solid materials have peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C.

Preferably solid material of the invention is a solid material according to general formula (I) as follows:

Li₄₋₂ₓZnₓP₂S₆ (I)

wherein 0<x≤1, preferably x is chosen from 0.2 to 0.7 and more preferably from 0.33 to 0.5.

The invention also concerns a method for producing a solid material of the invention, such as a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material according to general formula (I) as follows:

Li₄₋₂ₓZnₓP₂S₆ (I)

wherein 0<x≤1;
comprising at least bringing at least lithium sulfide, phosphorous sulfide and zinc compound, optionally in one or more solvents, then proceeding with a heat treatment at a temperature in the range of from 375° C. to 900° C., under an inert atmosphere, thereby forming the solid material.

The invention also refers to a solid material susceptible to be obtained by said process.

The invention also refers to a process for the preparation of a solid material according to general formula (I) as follows:

Li₄₋₂ₓZnₓP₂S₆ (I)

wherein 0<x≤1;
comprising at least the process steps of:
a) obtaining a composition by admixing stoichiometric amounts of lithium sulfide, phosphorous sulfide, and a zinc compound in order to obtain Li₄₋₂ₓZnₓP₂S₇, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 375° C. to 900° C., under an inert atmosphere, thereby forming the solid material; and
e) optionally treating the solid material obtained in step d) to the desired particle size distribution.

The invention furthermore concerns a solid material susceptible to be obtained by said process.

The invention also refers to the use of a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1;
as solid electrolyte.

The invention also refers to a solid electrolyte comprising at least a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1.

The invention also concerns an electrochemical device comprising at least a solid electrolyte comprising at least a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1.

The invention also refers to a solid state battery comprising at least a solid electrolyte comprising at least a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1.

The present invention also concerns a vehicle comprising at least a solid state battery comprising at least a solid electrolyte comprising at least a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1.

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “electrolyte” refers in particular to a material that allows ions, e.g., Li⁺, to migrate therethrough but which does not allow electrons to conduct therethrough. Electrolytes are useful for electrically isolating the cathode and anodes of a battery while allowing ions, e.g., Li⁺, to transmit through the electrolyte. The “solid electrolyte” according to the present invention means in particular any kind of material in which ions, for example, Li⁺, can move around while the material is in a solid state.

As used herein, the term “crystalline phase” refers to a material of a fraction of a material that exhibits a crystalline property, for example, well-defined x-ray diffraction peaks as measured by X-Ray Diffraction (XRD).

As used herein, the term “peaks” refers to (20) positions on the x-axis of an XRD powder pattern of intensity v. degrees (20) which have a peak intensity substantially greater than the background. In a series of XRD powder pattern peaks, the primary peak is the peak of highest intensity which is associated with the compound, or phase, being analyzed. The second primary peak is the peak of second highest intensity. The third primary peak is the peak of third highest intensity.

The term “electrochemical device” refers in particular to a device which generates and/or stores electrical energy by, for example, electrochemical and/or electrostatic processes. Electrochemical devices may include electrochemical cells such as batteries, notably solid state batteries. A battery may be a primary (i.e., single or “disposable” use) battery, or a secondary (i.e., rechargeable) battery.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more different sources of power, for example both gasoline-powered and electric-powered vehicles.

### DETAILED INVENTION

The present invention refers then to a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C. Preferably said solid materials as peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C.

The invention then also relates to a solid material according to general formula (I)

Li₄₋₂ₓZnₓP₂S₆ (I)

wherein 0<x≤1.

The solid material of the invention is neutrally charged. It is understood that formula (I) is an empirical formula (gross formula) determined by means of elemental analysis. Accordingly, formula (I) defines a composition which is averaged over all phases present in the solid material.

0<x≤1, preferably x is chosen from 0.2 to 0.7 and more preferably from 0.33 to 0.5, notably x is 0.05, 0.1, 0.15, 0.2, 0.25, 0.3, 0.35, 0.4, 0.45, 0.5, 0.55, 0.6, 0.65 and 0.66 or any range made from these values.

The solid material of the invention may be amorphous (glass) and/or crystallized (glass ceramics). Only part of the solid material may be crystallized. Preferably the solid material of the invention is fully crystalline. The crystallized part of the solid material may comprise only one crystal structure or may comprise a plurality of crystal structures.

Indexation in the trigonal space group P-31m is possible. The crystallographic space group of the solid material of the present invention is preferably space group 162 (P-31m). In this space group, cell parameters of the solid materials of the present invention may range from a=b=6.01 Angstrom to 6.11 Angstrom and c=6.55 Angstrom to c=6.64 Angstrom, as measured by x-ray diffraction using CuKα radiation at 25° C., and further calculated with a dedicated software, such as Fullprof software, using a refinement method such as Rietveld and Le Bail refinement. The volume per formula atom may range from 206 Å³/f.u to 215 Å³/f.u. For instance for solid material Li_{3.33}Zn_{0.33}P₂S₆, cell parameters are a=b=6.06 A and c=6.59 A and volume per formula atom is 209 Å³/f.u.

Preferably solid materials of formula (I) according to the present invention are chosen in the group consisting of: Li_{3.8}Zn_{0.1}P₂S₆, Li_{3.6}Zn_{0.2}P₂S₆, Li_{3.5}Zn_{0.25}P₂S₆, Li_{3.33}Zn_{0.33}P₂S₆, Li_{3.2}Zn_{0.4}P₂S₆, Li₃Zn_{0.5}P₂S₆, and Li_{2.666}Zn_{0.666}P₂S₆.

The composition of the compound of formula (I) may notably be determined by chemical analysis using techniques well known to the skilled person, such as for instance a X-Ray Diffraction (XRD) and an Inductively Coupled Plasma-Mass Spectrometry (ICP-MS).

Solid materials of the invention may be in powder form with a distribution of particle diameters having a D50 preferably comprised between 0.05 μm and 10 μm. The particle size can be evaluated with SEM image analysis or laser diffraction analysis.

D50 has the usual meaning used in the field of particle size distributions. Dn corresponds to the diameter of the particles for which n % of the particles have a diameter which is less than Dn. D50 (median) is defined as the size value corresponding to the cumulative distribution at 50%. These parameters are usually determined from a distribution in volume of the diameters of a dispersion of the particles of the solid material in a solution, obtained with a laser diffractometer, using the standard procedure predetermined by the instrument software. The laser diffractometer uses the technique of laser diffraction to measure the size of the particles by measuring the intensity of light diffracted as a laser beam passes through a dispersed particulate sample. The laser diffractometer may be the Mastersizer 3000 manufactured by Malvern for instance.

D50 may be notably measured after treatment under ultrasound. The treatment under ultrasound may consist in inserting an ultrasonic probe into a dispersion of the solid material in a solution, and in submitting the dispersion to sonication.

The invention also concerns a method for producing a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material according to general formula (I) as follows:

Li₄₋₂ₓZnₓP₂S₆ (I)

wherein 0<x≤1;
comprising at least bringing at least lithium sulfide, phosphorous sulfide and zinc compound, optionally in one or more solvents, then proceeding with a heat treatment at a temperature in the range of from 375° C. to 900° C., under an inert atmosphere, thereby forming the solid material.

One or more lithium sulfide, phosphorous sulfide, and zinc compound may be used.

Solid materials of the invention may be produced by any methods used in the prior art known for producing a Li₄P₂S₆, such as for instance a melt extraction method, a full solution method, a mechanical milling method or a slurry method in which raw materials are reacted, optionally in one or more solvents.

The invention then refers to a process for the preparation of a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., said process comprising at least the process steps of:

a) obtaining a composition by admixing stoichiometric amounts of lithium sulfide, phosphorous sulfide, and a zinc compound, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 375° C. to 900° C., under an inert atmosphere, thereby forming the solid material; and
e) optionally treating the solid material obtained in step d) to the desired particle size distribution.

The invention also refers to a process for the preparation of a solid material according to general formula (I), said process comprising at least the process steps of:

a) obtaining a composition by admixing stoichiometric amounts of lithium sulfide, phosphorous sulfide, and a zinc compound in order to obtain Li₄₋₂ₓZnₓP₂S₇, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 375° C. to 900° C., under an inert atmosphere, thereby forming the solid material; and
e) optionally treating the solid material obtained in step d) to the desired particle size distribution.

Inert atmosphere as used in step a) refers to the use of an inert gas; ie. a gas that does not undergo detrimental chemical reactions under conditions of the reaction. Inert gases are used generally to avoid unwanted chemical reactions from taking place, such as oxidation and hydrolysis reactions with the oxygen and moisture in air. Hence inert gas means gas that does not chemically react with the other reagents present in a particular chemical reaction. Within the context of this disclosure the term “inert gas” means a gas that does not react with the solid material precursors. Examples of an “inert gas” include, but are not limited to, nitrogen, helium, argon, carbon dioxide, neon, xenon, H₂S, O₂ with less than 1000 ppm of liquid and airborne forms of water, including condensation. The gas can also be pressurized.

It is preferred that stirring be conducted when the raw materials are brought into contact with each other under an atmosphere of an inert gas such as nitrogen or argon. The dew point of an inert gas is preferably −20° C. or less, particularly preferably −40° C. or less. The pressure may be from 0.0001 Pa to 100 MPa, preferably from 0.001 Pa to 20 MPa, preferably from 0.01 Pa to 0.5 MPa.

Preferably in step a), inert atmosphere comprises an inert gas such as H₂S, dry N₂, dry Argon or dry air (dry may refer to a gas with less than 800 ppm of liquid and airborne forms of water, including condensation).

The composition ratio of each element can be controlled by adjusting the amount of the raw material compound when the solid material is produced. The precursors and their molar ratio are selected according to the target stoichiometry for the production of the solid material of formula (I). The target stoichiometry defines the ratio between the elements Li, Zn, P and S, which is obtainable from the applied amounts of the precursors under the condition of complete conversion without side reactions and other losses.

Lithium sulfide refers to a compound including one or more of sulfur atoms and one or more of lithium atoms, or alternatively, one or more of sulfur containing ionic groups and one or more of lithium containing ionic groups. In certain preferred aspects, lithium sulfide may consist of sulfur atoms and lithium atoms. Preferably, lithium sulfide is Li₂S.

Phosphorus sulfide refers to a compound including one or more of sulfur atoms and one or more of phosphorus atoms, or alternatively, one or more of sulfur containing ionic groups and one or more of phosphorus containing ionic groups. In certain preferred aspects, phosphorus sulfide may consist of sulfur atoms and phosphorus atoms. Non-limiting exemplary phosphorus sulfide may include, but not limited to, P₂S₅, P₄S₃, P₄S₁₀, P₄S₄, P₄S₅, P₄S₆, P₄S₇, P₄S₈, and P₄S₉.

Zinc compound refers to a compound including one or more of Zn atoms via chemical bond (e.g., ionic bond or covalent bond) to the other atoms constituting the compound. In another aspect, zinc compound can be metallic zinc. In certain preferred aspect, the zinc compound may include one or more Zn atoms one or more non-metal atoms, such as S. Zinc compounds are preferably chosen in the group consisting of: ZnS and Zn. Zinc compound of the invention may also be a blend of metallic zinc and elementary sulfur.

Preferably, the solid material of the invention is made by using at least the precursors as follows: Li₂S, P₂S₅, and ZnS.

Preferably, lithium sulfide, phosphorous sulfide and zinc compound have an average particle diameter comprised between 0.5 μm and 400 μm. The particle size can be evaluated with SEM image analysis or laser diffraction analysis.

The solvent may suitably be selected from one or more of polar or non-polar solvents that may substantially dissolve at least one compound selected from: lithium sulfide, phosphorus sulfide, and zinc compound. Said solvent may also substantially suspend, dissolve or otherwise admix the above described components, e.g., lithium sulfide, phosphorus sulfide, and zinc compound.

Solvent of the invention then constitutes in step a) a continuous phase with dispersion of one or more of the above described components.

Depending on the components and the solvent, some of the components are then rather dissolved, partially dissolved or under a form of a slurry. (ie. component(s) is/are not dissolved and forming then a slurry with the solvent).

In certain preferred aspect, the solvent may suitably a polar solvent. Solvents are preferably polar solvents preferably selected in the group consisting of alkanols, notably having 1 to 6 carbon atoms, such as methanol, ethanol, propanol and butanol; carbonates, such as dimethyl carbonate; acetates, such as ethyl acetate; ethers, such as dimethyl ether, tetrahydrofuran; organic nitriles, such as acetonitrile; aliphatic hydrocarbons, such as hexane, pentane, 2-ethylhexane, heptane, decane, and cyclohexane; and aromatic hydrocarbons, such as xylene and toluene.

It is understood that references herein to “a solvent” includes one or more mixed solvents.

An amount of about 1 wt % to 80 wt % of the powder mixture and an amount of about 20 wt % to 99 wt % of the solvent, based on the total weight of the powder mixture and the solvent, may be mixed. Preferably, an amount of about 25 wt % to 75 wt % of the powder mixture and an amount of 25 wt % to 75 wt % of the solvent, based on the total weight of the powder mixture and the solvent, may be mixed. Particularly, an amount of about 40 wt % to 60 wt % of the powder mixture and an amount of about 40 wt % to 60 wt % of the solvent, based on the total weight of the powder mixture and the solvent, may be mixed.

The temperature of step a) in presence of solvent is preferably between the fusion temperature of the selected solvent and ebullition temperature of the selected solvent at a temperature where no unwanted reactivity is found between solvent and admixed compounds. Preferably step a) is done between −20° C. and 40° C. and more preferably between 15° C. and 40° C. In absence of solvent step a) is done at a temperature between −20° C. and 200° C. and preferably between 15° C. and 40° C. Duration of step a) is preferably between 1 minute and 1 hour.

Mechanical treatment to the composition in step b) may be performed by wet or dry milling; notably be performed by adding the powder mixture to a solvent and then milling at about 100 rpm to 1000 rpm, notably for a duration from 10 minutes to 80 hours more preferably for about 4 hours to 40 hours.

Said milling is also known as reactive-milling in the conventional synthesis of LiPS compounds.

The mechanical milling method also has an advantage that, simultaneously with the production of a glass mixture, pulverization occurs. In the mechanical milling method, various methods such as a rotation ball mill, a tumbling ball mill, a vibration ball mill and a planetary ball mill or the like can be used. Mechanical milling may be made with or without balls such as ZrO₂.

In such a condition, lithium sulfide, phosphorous sulfide and zinc compound are allowed to react in a solvent for a predetermined period of time.

The temperature of step b) in presence of solvent is between the fusion temperature of the selected solvent and ebullition temperature of the selected solvent at a temperature where no unwanted reactivity is found between solvent and compounds. Preferably step b) is done at a temperature between −20° C. and 80° C. and more preferably between 15° C. and 40° C. In absence of solvent step a) is done between −20° C. and 200° C. and preferably between 15° C. and 40° C.

Mechanical treatment to the composition in step b) may also be performed by stirring, notably by using well known techniques in the art, such as by using standard powder or slurry mixers.

Usually a paste or a blend of paste and liquid solvent may be obtained at the end of step b).

In step c), at least a portion of the solvent is removed notably means to remove at least about 30%, 40%, 50%, 60%, 70%, 80%, 90% 95% or 100%, of the total weight of a solvent used, or any ranges comprised between these values. Solvent removal may be carried out by known methods used in the art, such as decantation, filtration, centrifugation, drying or a combination thereof.

The temperature in step c) is selected to allow removal of solvent. Preferably when drying is selected as method for solvent removal, temperature is selected below ebullition temperature and as a function of vapor partial pressure of the selected solvent.

Duration of step c) is between 1 second and 100 hours, preferably between 1 hour and 20 hours. Such a low duration may be obtained for instance by using a flash evaporation, such as by spray drying.

It is preferred that step c) be conducted under an atmosphere of an inert gas such as nitrogen or argon. The dew point of an inert gas is preferably −20° C. or less, particularly preferably −40° C. or less. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

In step d) the heating, or thermal treatment, may notably allow to convert the amorphized powder mixture (glass) obtained above into a solid material crystalline or mixture of glass and crystalline (glass ceramics).

Heat treatment is carried out at a temperature in the range of from 375° C. to 900° C., preferably from 400° C. to 700° C., more preferably from 550° C. to 650° C., notably for a duration of 1 minute to 100 hours, preferably from 4 hours to 40 hours. Heat treatment may start directly at high temperature or via a ramp of temperature at a rate comprised between 1° C./min to 20° C./min. Heat treatment may finish with an air quenching or via natural cooling from the heating temperature or via a controlled ramp of temperature at a rate comprised between 1° C./min to 20° C./min.

Preferably in step d), inert atmosphere comprises an inter gas such as dry N₂, or dry Argon (dry may refer to a gas with less than 800 ppm of liquid and airborne forms of water, including condensation). Preferably in step d) the inert atmosphere is a protective gas atmosphere used in order to minimize, preferably exclude access of oxygen and moisture.

The pressure at the time of heating may be at normal pressure or under reduced pressure. The atmosphere may be inert gas, such as nitrogen and argon. The dew point of the inert gas is preferably −20° C. or less, with −40° C. or less being particularly preferable. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

Without being bound by the theory, heat treatment at step d) allows sublimation of S element and generation of a solid material according to general formula (I), notably by the reaction as follows:

(2−x)Li₄₋₂ₓZn_{y}P₂S_{7-(x-y)}+(x−y)ZnS=Li₄₋₂ₓZnₓP₂S₆+S

In step e), it is possible to treat the solid material to the desired particle size distribution. If necessary, the solid material obtained by the process according to the invention as described above is ground (e.g. milled) into a powder. Preferably, said powder has a D50 value of the particle size distribution of less than 100 μm, more preferably less than 10 μm, most preferably less than 5 μm, as determined by means of dynamic light scattering or image analysis.

Preferably, said powder has a D90 value of the particle size distribution of less than 100 μm, more preferably less than 10 μm, most preferably less than 5 μm, as determined by means of dynamic light scattering or image analysis. Notably, said powder has a D90 value of the particle size distribution comprised from 1 μm to 100 μm.

The invention also refers to a solid material of the invention as solid electrolyte, as well as a solid electrolyte comprising at least a solid material of the invention. Said solid electrolytes comprises then at least a solid material of the invention, notably a solid material of formula (I), and optionally another solid electrolyte, such as a lithium argyrodites, lithium thiophosphates, such as glass or glass ceramics Li₃PS₄, Li₇PS₁₁, and lithium conducting oxides such as lithium stuffed garnets Li₇La₃Zr₂O₁₂ (LLZO).

Said solid electrolytes may also optionally comprise polymers such as styrene butadiene rubbers, organic or inorganic stabilizers such as SiO₂ or dispersants.

The invention also concerns an electrochemical device comprising a solid electrolyte comprising at least a solid material of the invention, notably a solid material of formula (I).

Preferably in the electrochemical device, particularly a rechargeable electrochemical device, the solid electrolyte is a component of a solid structure for an electrochemical device selected from the group consisting of cathode, anode and separator.

Herein preferably the solid electrolyte is a component of a solid structure for an electrochemical device, wherein the solid structure is selected from the group consisting of cathode, anode and separator. Accordingly, the solid materials according to the invention can be used alone or in combination with additional components for producing a solid structure for an electrochemical device, such as a cathode, an anode or a separator.

The electrode where during discharging a net negative charge occurs is called the anode and the electrode where during discharging a net positive charge occurs is called the cathode. The separator electronically separates a cathode and an anode from each other in an electrochemical device.

Suitable electrochemically active cathode materials and suitable electrochemically active anode materials are well known in the art. In an electrochemical device according to the invention, the anode preferably comprises graphitic carbon, metallic lithium, silicon compounds such as Si, SiOₓ, lithium titanates such as Li₄Ti₅O₁₂ or a metal alloy comprising lithium as the anode active material such as Sn.

In an electrochemical device according to the invention, the cathode preferably comprises a metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1), and spinel-structured LiMn₂O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}Co_{1/3}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂. Cathode may comprise a lithiated or partially lithiated transition metal oxyanion-based material such as LiFePO₄.

For example, the electrochemical device has a cylindrical-like or a prismatic shape. The electrochemical device can include a housing that can be from steel or aluminum or multilayered films polymer/metal foil.

A further aspect of the present invention refers to batteries, more preferably to an alkali metal battery, in particular to a lithium battery comprising at least one inventive electrochemical device, for example two or more. Electrochemical devices can be combined with one another in inventive alkali metal batteries, for example in series connection or in parallel connection.

The invention also concerns a solid state battery comprising a solid electrolyte comprising at least a solid material of the invention, notably a solid material of formula (I).

Typically, a lithium solid-state battery includes a positive electrode active material layer containing a positive electrode active material, a negative electrode active material layer containing a negative electrode active material, and a solid electrolyte layer formed between the positive electrode active material layer and the negative electrode active material layer. At least one of the positive electrode active material layer, the negative electrode active material layer, and the solid electrolyte layer includes a solid electrolyte as defined above.

The cathode of an all-solid-state electrochemical device usually comprises beside an active cathode material as a further component a solid electrolyte. Also the anode of an all-solid state electrochemical device usually comprises a solid electrolyte as a further component beside an active anode material.

The form of the solid structure for an electrochemical device, in particular for an all-solid-state lithium battery, depends in particular on the form of the produced electrochemical device itself. The present invention further provides a solid structure for an electrochemical device wherein the solid structure is selected from the group consisting of cathode, anode and separator, wherein the solid structure for an electrochemical device comprises a solid material according to the invention.

A plurality of electrochemical cells may be combined to an all solid-state battery, which has both solid electrodes and solid electrolytes.

The solid material disclosed above may be used in the preparation of an electrode. The electrode may be a positive electrode or a negative electrode.

The electrode typically comprises at least:
a metal substrate;
directly adhered onto said metal substrate, at least one layer made of a composition comprising:
   (i) a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1;
(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS);
(vi) optionally at least one polymeric binding material (P).

The electro-active compound (EAC) denotes a compound which is able to incorporate or insert into its structure and to release lithium ions during the charging phase and the discharging phase of an electrochemical device. An EAC may be a compound which is able to intercale and deintercalate into its structure lithium ions. For a positive electrode, the EAC may be a composite metal chalcogenide of formula LiMeQ₂ wherein:
Me is at least one metal selected in the group consisting of Co, Ni, Fe, Mn, Cr, Al and V;
Q is a chalcogen such as O or S.

The EAC may more particularly be of formula LiMeO₂. Preferred examples of EAC include LiCoO₂, LiNiO₂, LiMnO₂, LiNiₓCo₁₋ₓO₂ (0<x<1), LiNiₓCo_{y}Mn_{z}O₂ (0<x, y, z<1 and x+y+z=1) for instance LiNi_{1/3}Mn_{1/3}Co_{1/3}O₂, LiNi_{0.6}Mn_{0.2}Co_{0.2}O₂, LiNi_{0.8}Mn_{0.1}Co_{0.1}O₂, Li(NiₓCo_{y}Al_{z})O₂ (x+y+z=1) and spinel-structured LiMn₂O₄ and Li (Ni_{0.5}Mn_{1.5})O₄.

The EAC may also be a lithiated or partially lithiated transition metal oxyanion-based electro-active material of formula M₁M₂(JO₄)_{f}E_{1-f}, wherein:
M₁ is lithium, which may be partially substituted by another alkali metal representing less than 20% of M₁;
M₂ is a transition metal at the oxidation level of +2 selected from Fe, Co, Mn, Ni or mixtures thereof, which may be partially substituted by one or more additional metals at oxidation levels between +1 and +5 and representing less than 35% of the M₂ metals, including 0;
JO₄ is any oxyanion wherein J is either P, S, V, Si, Nb, Mo or a combination thereof;
E is a fluoride, hydroxide or chloride anion;
f is the molar fraction of the JO₄ oxyanion, generally comprised between 0.75 and 1.

The M₁M₂(JO₄)_{f}E_{1-f} electro-active material as defined above is preferably phosphate-based. It may exhibit an ordered or modified olivine structure.

For a positive electrode, the EAC may also be sulfur or Li₂S.

For a positive electrode, the EAC may also be a conversion-type materials such as FeS₂ or FeF₂ or FeF₃

For a negative electrode, the EAC may be selected in the group consisting of graphitic carbons able to intercalate lithium. More details about this type of EAC may be found in Carbon 2000, 38, 1031-1041. This type of EAC typically exist in the form of powders, flakes, fibers or spheres (e.g. mesocarbon microbeads).

The EAC may also be: lithium metal; lithium alloy compositions (e.g. those described in U.S. Pat. No. 6,203,944 and in WO 00/03444); lithium titanates, generally represented by formula Li₄Ti₅O₁₂; these compounds are generally considered as “zero-strain” insertion materials, having low level of physical expansion upon taking up the mobile ions, i.e. Li⁺; lithium-silicon alloys, generally known as lithium silicides with high Li/Si ratios, in particular lithium silicides of formula Li_{4.4}Si and lithium-germanium alloys, including crystalline phases of formula Li_{4.4}Ge. EAC may also be composite materials based on carbonaceous material with silicon and/or silicon oxide, notably graphite carbon/silicon and graphite/silicon oxide, wherein the graphite carbon is composed of one or several carbons able to intercalate lithium.

The ECM is typically selected in the group consisting of electro-conductive carbonaceous materials and metal powders or fibers. The electron-conductive carbonaceous materials may for instance be selected in the group consisting of carbon blacks, carbon nanotubes, graphite, graphene and graphite fibers and combinations thereof. Examples of carbon blacks include ketjen black and acetylene black. The metal powders or fibers include nickel and aluminum powders or fibers.

The lithium salt (LIS) may be selected in the group consisting of LiPF₆, lithium bis(trifluoromethanesulfonyl)imide, lithium bis(fluorosulfonyl)imide, LiB(C₂O₄)₂, LiAsF₆, LiClO₄, LiBF₄, LiAlO₄, LiNO₃, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiCF₃SO₃, LiAlCl₄, LiSbF₆, LiF, LiBr, LiCl, LiOH and lithium 2-trifluoromethyl-4,5-dicyanoimidazole.

The function of the polymeric binding material (P) is to hold together the components of the composition. The polymeric binding material is usually inert. It preferably should be also chemically stable and facilitate the electronic and ionic transport. The polymeric binding material is well known in the art. Non-limitative examples of polymeric binder materials include notably, vinylidenefluoride (VDF)-based (co)polymers, styrene-butadiene rubber (SBR), styrene-ethylene-butylene-styrene (SEBS), carboxymethylcellulose (CMC), polyamideimide (PAD, poly(tetrafluoroethylene) (PTFE) and poly(acrylonitrile) (PAN) (co)polymers.

The proportion of the solid material of the invention in the composition may be between 0.1 wt % to 80 wt %, based on the total weight of the composition. In particular, this proportion may be between 1.0 wt % to 60 wt %, more particularly between 5 wt % to 30 wt %. The thickness of the electrode is not particularly limited and should be adapted with respect to the energy and power required in the application. For example, the thickness of the electrode may be between 0.01 mm to 1.000 mm.

The solid material of the invention may also be used in the preparation of a separator. A separator is an ionically permeable membrane placed between the anode and the cathode of a battery. Its function is to be permeable to the lithium ions while blocking electrons and assuring the physical separation between the electrodes.

The separator of the invention typically comprises at least:
a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., preferably a solid material of formula (I) as follows:

Li₄₋₂ₓZnₓP₂S₆ (I)

wherein 0<x≤1;
optionally at least one polymeric binding material (P);
optionally at least one metal salt, notably a lithium salt;
optionally at least one plasticizer.

The electrode and the separator may be prepared using methods well-known to the skilled person. This usually mixing the components in an appropriate solvent and removing the solvent. For instance, the electrode may be prepared by the process which comprises the following steps:
a slurry comprising the components of composition and at least one solvent is applied onto the metal substrate;
the solvent is removed.

Usual techniques known to the skilled person are the following ones: coating and calendaring, dry and wet extrusion, 3D printing, sintering of porous foam followed by impregnation. Usual techniques of preparation of the electrode and of the separator are provided in Journal of Power Sources, 2018 382, 160-175.

The electrochemical devices, notably batteries such as solid state batteries described herein, can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

The electrochemical devices, notably batteries such as solid state batteries described herein, can notably be used in motor vehicles, bicycles operated by electric motor, robots, aircraft (for example unmanned aerial vehicles including drones), ships or stationary energy storages. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

Should the disclosure of any patents, patent applications, and publications which are incorporated herein by reference conflict with the description of the present application to the extent that it may render a term unclear, the present description shall take precedence.

### FIGURES

FIG. 1: powder XRD pattern of samples of Examples 1˜4 and 6. Circle highlight ZnS contribution in Example 4.

FIG. 2: powder XRD pattern of samples of Example 2 and Example 5. Stars indicate diffraction peaks of LiZnPS₄-type phase in Example 5.

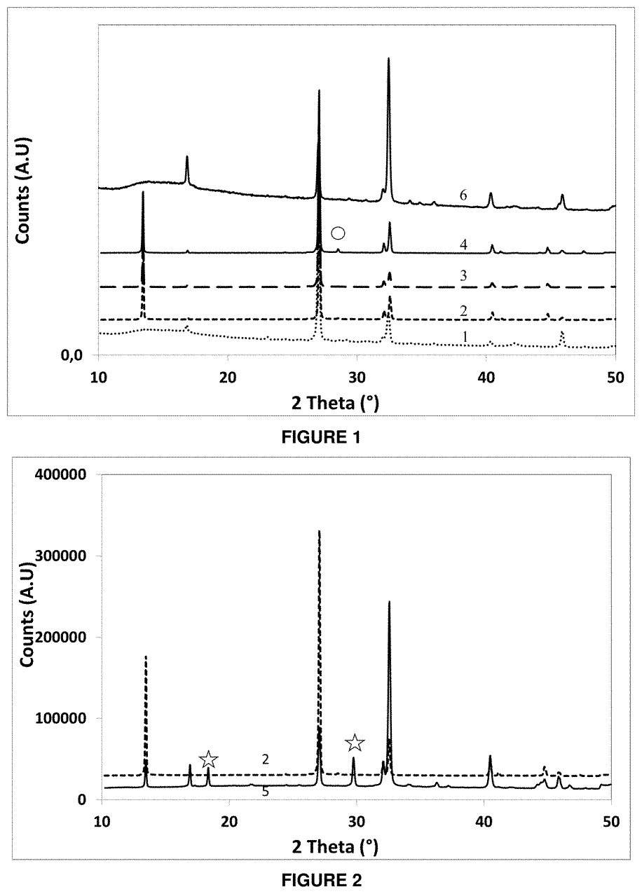

### EXPERIMENTAL PART

The examples below serve to illustrate the invention, but have no limiting character.

X-Ray Diffraction

X-Ray Diffraction of the samples were collected using a Bruker D8 diffractometer with Cu Kα radiation at RT (except example 1 that was collected with Co Kα radiation at 25° C.) The samples were sealed in a Be-equipped sample holder in an Ar filled glovebox prior to the experiment. The diffractions were collected in 28 range of 10° to 100° in 13 hours. The lattice parameters were determined by fitting the diffraction profiles using Full-Prof Suite.

Conductivity & Electrochemical Impedance Spectroscopy (EIS)

Before the impedance spectroscopy measurements, powder samples were cold-pressed at 530 MPa in an Ar filled glovebox. The pellets were then sandwiched between pre-dried carbon paper electrodes, and then loaded into air-tight sample holders. The AC impedance spectra were collected by using Biologic MTZ-35 frequency response analyser. During the measurements, the AC potential for excitation was set at 50 mV for all the samples. The frequency range of the measurement of the Example 1 was 0.01 Hz to 30 MHz, whereas a range of 0.1 Hz to 30 MHz was applied in the measurements of the Example 2, the Example 3, the Example 4 and the Counter Example 5. The impedance measurements took place at stabilized temperatures between 20° C. and 60° C. for the Example 1, −10° C. and 80° C. for the Example 2, −10° C. and 70° C. for the Example 3, 0° C. and 50° C. for the Example 4 and 0° C. and 80° C. for the Example 5, in steps of 10° C. The ionic conductivity values were obtained by fitting the data into equivalent circuit models using ZView software. The slopes of the σT versus 1/T plots were used to determine activation energy values.

Moisture Stability

Moisture stability was measured using a H₂S sensor (Sensorcon Industrial Pro from Molex). H₂S liberation kinetic was measured at 23° C. with 30 mg of each sample in a 10 L desiccator filled with ambient non-dried air (relative humidity between 70% and 90%, non-controlled). Values showed (in ppm) by the sensor are recorded every 20 seconds for 15 minutes and converted in number of moles of H₂S generated per liter of ambient air and gram of sample.

### Counter Example 1: Li4P2S6 Synthesized Via Solid State Route

Li₂S and P₂S₅ (both produced by Sigma Aldrich, ≥99%), were used as starting materials, mixed with mortar and pestle in an Ar filled glovebox. The resulting powder was pelletized at 530 MPa with a 6 mm diameter die. The pellet vacuum sealed in a carbon coated quartz tube, then the tube was annealed at 750° C. for 60 hours. After the annealing step, the tube was slowly cooled down to 25° C., and it was opened in an Ar filled glovebox.

The XRD pattern shows a well-crystalline material, with XRD peaks (28 position with Cu alpha wavelength): at 16.8°, 27°, 32°, 32.4°. Indexation in the trigonal space group P-31m is possible and cell parameters are a=b=6.08 Å and c=6.60 Å and the volume per formula atom is 211 Å³/f.u.

Ionic conductivity at 60° C. is 9*10⁻⁹ S/cm with an activation energy of 0.61 eV. Ionic conductivity at room temperature was too low to be measured directly, around 10⁻⁹ S/cm.

H₂S generation after 12 minutes was 54 μmol/Lₐᵢᵣ/gₛₐₘₚₗₑ.

### Example 2: Li_{3.33}Zn_{0.33}P₂S₆

Li₂S, P₂S₅ (both produced by Sigma Aldrich, ≥99%), and ZnS (produced by Alfa Aesar 99%) were used as starting materials. 2 g of total powder at the desired molar ratio were put in a 45 mL ZrO₂ jar with 15 ZrO₂ balls (3 g/ball, 10 mm diameter) in an Ar filled glovebox. The jar was sealed with scotch and parafilm to prevent air exposure, then was taken out of the glovebox and was placed in Fritzch Planetary Micro Mill Pulverisette 7. It was ball-milled with 510 RPM rotating speed for 38 hours while employing 15 minute breaks in every 15 minutes of milling, in order to prevent excessive heating of the jar. The jar was then moved in an Ar filled glovebox to collect the powder. The resulting powder was pelletized at 530 MPa with a 6 mm diameter die. The pellet was vacuum sealed in a carbon coated quartz tube, then the tube was annealed at 600° C. for 36 hours. After the annealing step, the tube was slowly cooled down to 25° C., and it was opened in an Ar filled glovebox.

The XRD pattern shows a well-crystalline material, with XRD peaks at (28 position with Cu alpha wavelength): 13.4°, 16.9°, 27.1°, 32.1°, 32.6°. Indexation in the trigonal space group P-31m is possible, cell parameters are a=b=6.06 A and c=6.59 A and the volume per formula atom is 209 Å³/f.u.

No extra phase is detected, proving that Zn is inserted in the structure.

Ionic conductivity at 25° C. is 1·10⁻⁶ S/cm with an activation energy of 0.51 eV.

H₂S generation after 12 minutes was 14 μmol/Lₐᵢᵣ/gₛₐₘₚₗₑ.

### Example 3: Li₃Zn_{0.5}P₂S₆

Li₂S, P₂S₅ (both produced by Sigma Aldrich, ≥99%) and ZnS (produced by Alfa Aesar 99%) were used as starting materials. 2 g of total powder at the desired molar ratio were put in a 45 mL ZrO₂ jar with 12 ZrO₂ balls (3 g/ball, 10 mm diameter) in an Ar filled glovebox. The jar was sealed with scotch and parafilm to prevent air exposure, then was taken out of the glovebox and was placed in Fritsch Planetary Micro Mill Pulverisette 7. It was ball-milled with 510 RPM rotating speed for 38 hours while employing 15 minute breaks in every 15 minutes of milling, in order to prevent excessive heating of the jar. The jar was then moved in an Ar filled glovebox to collect the powder. The resulting powder was pelletized at 530 MPa with a 6 mm diameter die. The pellet vacuum sealed in a carbon coated quartz tube, then the tube was annealed at 600° C. for 36 hours. After the annealing step, the tube was slowly cooled down to 25° C., and it was opened in an Ar filled glovebox.

The XRD pattern shows a well-crystalline material, with XRD peaks at (28 position with Cu alpha wavelength): 13.4°, 16.9°, 27°, 32°, 32.5°. Indexation in the trigonal space group P-31m is possible, cell parameters are a=b=6.06 A and c=6.59 A and the volume per formula atom is 210 Å³/f.u.

No extra phase is detected, proving that Zn is inserted in the new structure.

Ionic conductivity at 20° C. is 3·10⁻⁷ S/cm with an activation energy of 0.51 eV.

H₂S generation after 12 minutes was 1 μmol/Lₐᵢᵣ/gₛₐₘₚₗₑ.

### Example 4: Li_{2.666}Zn_{0.666}P₂S₆

Li₂S, P₂S₅ (both produced by Sigma Aldrich, ≥99%) and ZnS (produced by Alfa Aesar 99%) were used as starting materials. 2 g of total powder at the desired molar ratio were put in a 45 mL ZrO₂ jar with 15 ZrO₂ balls (3 g/ball, 10 mm diameter) in an Ar filled glovebox. The jar was sealed with scotch and parafilm to prevent air exposure, then was taken out of the glovebox and was placed in Fritsch Planetary Micro Mill Pulverisette 7. It was ball-milled with 510 RPM rotating speed for 38 hours while employing 15 minute breaks in every 15 minutes of milling, in order to prevent excessive heating of the jar. The jar was then moved in an Ar filled glovebox to collect the powder. The resulting powder was pelletized at 530 MPa with a 6 mm diameter die. The pellet vacuum sealed in a carbon coated quartz tube, then the tube was annealed at 600° C. for 36 hours. After the annealing step, the tube was slowly cooled down to 25° C., and it was opened in an Ar filled glovebox.

The XRD pattern shows a well-crystalline material, with XRD peaks at (28 position with Cu alpha wavelength): 13.4°, 16.9°, 27°, 32.1°. 32.5°. Indexation in the trigonal space group P-31m is possible, cell parameters are a=b=6.06 A and c=6.59 A and the volume per formula atom is 209 Å³/f.u.

Small amount of ZnS extra phase is detected, proving that large part of Zn is inserted in the structure but that solubility limit is probably reached.

Ionic conductivity at 20° C. is 5·10⁻⁷ S/cm with an activation energy of 0.56 eV.

H₂S generation after 12 minutes was 0 μmol/Lₐᵢᵣ/gₛₐₘₚₗₑ.

### Counter Example 5: Li_{3.33}Zn_{0.33}P₂S₆ at 350° C.

Li₂S, P₂S₅ (both produced by Sigma Aldrich, ≥99%?) and ZnS (produced by Alfa Aesar) were used as starting materials. 2 g of total powder at the desired molar ratio were put in a 45 mL ZrO₂ jar with 15 ZrO₂ balls (3 g/ball, 10 mm diameter) in an Ar filled glovebox. The jar was sealed with scotch and parafilm to prevent air exposure, then was taken out of the glovebox and was placed in Fritsch Planetary Micro Mill Pulverisette 7. It was ball-milled with 510 RPM rotating speed for 38 hours while employing 15 minute breaks in every 15 minutes of milling, in order to prevent excessive heating of the jar. The jar was then moved in an Ar filled glovebox to collect the powder. The resulting powder was pelletized at 530 MPa with a 6 mm diameter die. The pellet vacuum sealed in a carbon coated quartz tube, then the tube was annealed at 350° C. for 36 hours. After the annealing step, the tube was slowly cooled down to 25° C., and it was opened in an Ar filled glovebox.

The XRD pattern shows well-crystalline materials, with XRD peaks at (28 position with Cu alpha wavelength): 13.4°, 16.9°, 18.3°, 27°, 29.7°, 32.1°, 32.5°.

This set of diffraction peaks can be indexed as the combination of a Zn doped Li₄P₂S₆ phase and a LiZnPS4-type phase. The peaks around 18.3° and 29.7° point to the presence of LiZnPS4-type phase.

Ionic conductivity at 20° C. is 3·10⁻⁷ S/cm with an activation energy of 0.56 eV.

H₂S generation after 12 minutes was 19 μmol/Lₐᵢᵣ/gₛₐₘₚₗₑ.

### Counter Example 6: Li₄P₂S₆ Synthesized Via Ball Milling at 350° C.

Li₂S, P₂S₅ (both produced by Sigma Aldrich, ≥99%) were used as starting materials. 5 g of total powder at the desired molar ratio were put in a 45 mL ZrO2 jar with 15 ZrO2 balls (3 g/ball, 10 mm diameter) in an Ar filled glovebox. The jar was sealed with scotch and parafilm to prevent air exposure, then was taken out of the glovebox and was placed in Fritsch Planetary Micro Mill Pulverisette 7. It was ball-milled with 510 RPM rotating speed for 64 hours while employing 15 minute breaks in every 15 minutes of milling, in order to prevent excessive heating of the jar. The jar was then moved in an Ar filled glovebox to collect the powder. The resulting powder was pelletized at 530 MPa with a 6 mm diameter die. The pellet vacuum sealed in a carbon coated quartz tube, then the tube was annealed at 350° C. for 36 hours. After the annealing step, the tube was slowly cooled down to 25° C., and it was opened in an Ar filled glovebox.

The XRD pattern shows a well-crystalline material, with XRD peaks (28 position with Cu alpha wavelength): at 16.8°, 27°, 32°, 32.4°. Indexation in the trigonal space group P-31m is possible and cell parameters are a=b=6.08 Å and c=6.61 Å and the volume per formula atom is 211 Å³/f.u.

Ionic conductivity at was too low to be measured directly, so estimated 10⁻¹⁰ S/cm at 25° C.

H₂S generation after 12 minutes was 126 μmol/Lₐᵢᵣ/gₛₐₘₚₗₑ.

1. A solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C.

2. (canceled)

3. The solid material according to claim 1 wherein the solid material is of general formula (I) as follows:
Li₄₋₂ₓZnₓP₂S₆ (I)
wherein 0<x≤1.

4. The solid material according to claim 1 wherein x is chosen from 0.33 to 0.5.

5. The solid material according to claim 1 wherein it is in powder form with a distribution of particle diameters having a D50 comprised between 0.05 μm and 10 μm.

6. The solid material according to claim 1 wherein the solid is selected from a group consisting of: Li_{3.8}Zn_{0.1}P₂S₆, Li_{3.6}Zn_{0.2}P₂S₆, Li_{3.5}Zn_{0.25}P₂S₆, Li_{3.33}Zn_{0.33}P₂S₆, Li_{3.2}Zn_{0.4}P₂S₆, Li₃Zn_{0.5}P₂S₆, and Li_{2.666}Zn_{0.666}P₂S₆.

7. A method for producing the solid material according to claim 1 comprising at least bringing at least lithium sulfide, phosphorous sulfide and zinc compound, optionally in one or more solvents, then proceeding with a heat treatment at a temperature in the range of from 375° C. to 900° C., under an inert atmosphere, thereby forming the solid material.

8. A process for the preparation of a solid material comprising Li, Zn, P and S elements and exhibiting at least peaks at position of: 13.4°+/−0.5°, 16.9°+/−0.5°, 27.1°+/−0.5°, 32.1°+/−0.5°, 32.6°+/−0.5° when analyzed by x-ray diffraction using CuKα radiation at 25° C., said process comprising at least the process steps of:
a) obtaining a composition by admixing stoichiometric amounts of lithium sulfide, phosphorous sulfide, and a zinc compound, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 370° C. to 900° C., under an inert atmosphere, thereby forming the solid material; and
e) optionally treating the solid material obtained in step d) to the desired particle size distribution.

9. A process for the preparation of a solid material according to general formula (I) as follows:
Li₄₋₂ₓZnₓP₂S₆ (I)
wherein 0<x≤1, preferably x is chosen from 0.2 to 0.7;
said process comprising at least the process steps of:
a) obtaining a composition by admixing stoichiometric amounts of lithium sulfide, phosphorous sulfide, and a zinc compound in order to obtain Li₄₋₂ₓZnₓP₂S₇, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 375° C. to 900° C., under an inert atmosphere, thereby forming the solid material; and
e) optionally treating the solid material obtained in step d) to the desired particle size distribution.

10. The process according to claim 8 wherein the zinc compound is chosen in the group consisting of ZnS and Zn.

11. The process according to claim 8 wherein lithium sulfide is Li2S, phosphorous sulfide is P2S5, and zinc compound is ZnS.

12. The process according to claim 8 wherein the solvent is selected in the group consisting of alkanols, notably having 1 to 6 carbon atoms, such as methanol, ethanol, propanol and butanol; carbonates, such as dimethyl carbonate; acetates, such as ethyl acetate; ethers, such as dimethyl ether, tetrahydrofuran; organic nitriles, such as acetonitrile; aliphatic hydrocarbons, such as hexane, pentane, 2-ethylhexane, heptane, decane, and cyclohexane; and aromatic hydrocarbons, such as xylene and toluene.

13. The process according to claim 8 wherein in step b) the mechanical treatment is performed by wet or dry milling.

14. The process according to claim 8 wherein the heat treatment is carried out in step d) at a temperature in the range of from 400° C. to 700° C.

15. (canceled)

16. The solid electrolyte of claim 17, wherein the solid material is of formula (I) as follows:
Li₄₋₂ₓZnₓP₂S₆ (I)
wherein 0<x≤1.

17. A solid electrolyte comprising at least the solid material of claim 1.

18. An electrochemical device comprising at least a solid electrolyte comprising at least the solid material of claim 1.

19. A solid state battery comprising at least a solid electrolyte comprising at least the solid material of claim 1.

20. A vehicle comprising at least a solid state battery comprising at least a solid electrolyte comprising at least the solid material of claim 1.

21. An electrode comprising at least:
a metal substrate;
directly adhered onto said metal substrate, at least one layer made of a composition comprising:
(i) the solid material according to claim 1;
(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS); and
(vi) optionally at least one polymeric binding material (P).

22. A separator comprising at least:
the solid material according to claim 1;
optionally at least one polymeric binding material (P);
optionally at least one metal salt, notably a lithium salt; and
optionally at least one plasticizer.
